(19) United States
(12) Patent Application Publication
(10) Pub. No.: US 2019/0129710 A1
(43) Pub. Date: May 2, 2019

(54) CONTROL APPARATUS, METHOD FOR DETERMINING WHETHER OR NOT A CONTROL PROGRAM IS UPDATABLE, AND COMPUTER PROGRAM

(71) Applicant: Sumitomo Electric Industries, Ltd., Osaka-shi (JP)

(72) Inventor: Tatsuya Izumi, Osaka-shi (JP)

(21) Appl. No.: 16/306,209

(22) PCT Filed: May 22, 2017
(86) PCT No.: PCT/JP2017/019054

§ 371 Date: Nov. 30, 2018

(30) Foreign Application Priority Data
Jun. 2, 2016 (JP) 2016-110613
Oct. 27, 2016 (JP) 2016-210148

(51) Int. Cl. G06F 8/65; G05B 19/042; H04L 29/08

(52) U.S. Cl. CPC G06F 8/65; G05B 19/0426; G05D 1/0088; G05B 2219/23328; H04L 67/34

(57) ABSTRACT

Provided is a control apparatus for controlling update of a control program of an on-vehicle control device configured to control a target device installed on a vehicle. The control apparatus includes: an acquisition unit configured to acquire a use pattern of the control function of the on-vehicle control device during traveling of the vehicle; and a control unit configured to determine, based on the acquired use pattern, whether or not the control program regarding the on-vehicle control device is updatable.

### TECHNICAL FIELD

The present invention relates to a control apparatus, a method for determining whether or not a control program is updatable, and a computer program.

This application claims priority on Japanese Patent Application No. 2016-110613 filed on Jun. 2, 2016 and Japanese Patent Application No. 2016-210148 filed on Oct. 27, 2016, the entire contents of which are incorporated herein by reference.

### BACKGROUND ART

In the automotive field in recent years, vehicles have progressed in functionality, and a diverse range of devices are installed in vehicles. Accordingly, vehicles are equipped with large numbers of control devices, so-called ECUs (Electronic Control Units), for controlling these on-vehicle devices.

Each vehicle is equipped with various types of ECUs such as: traveling-related ECUs that control an engine, a brake, an EPS (Electric Power Steering), etc., in response to operations on an accelerator, a brake, and a handle; body-related ECUs that control ON/OFF of interior lights and headlights, sound of an alarm unit, etc., in response to switch operations performed by an occupant; and meter-related ECUs that control operations of meters arranged near the driver's seat.

Generally, each ECU consists of an arithmetic processing unit such as a microcomputer, and implements control of an on-vehicle device by reading out a control program stored in an ROM (Read Only Memory) and executing the read control program.

Control programs of ECUs may differ depending on the destinations, grades, and the like of vehicles. Therefore, old versions of control programs need to be overwritten with new versions of control programs in response to version upgrading of control programs.

For example, Patent Literature 1 discloses a vehicle control device which, when a control program of an ECU needs to be updated, sets a traveling route on which the ECU will not execute a control process. When the vehicle is traveling on the traveling route, the vehicle control device determines that the control process of the ECU is not performed, and causes the ECU to execute program update.

According to the vehicle control device of Patent Literature 1, since program update is executed when the vehicle is traveling, during which the ECU does not perform the control process, the program update can be executed early.

### CITATION LIST

### Patent Literature

PATENT LITERATURE 1: Japanese Laid-Open Patent Publication No. 2011-79486

### SUMMARY OF INVENTION

(1) A control apparatus according to one aspect of the present disclosure is an apparatus for controlling update of a control program of an on-vehicle control device configured to control a target device installed on a vehicle, and the control apparatus includes: an acquisition unit configured to acquire a use pattern of the control function of the on-vehicle control device during traveling of the vehicle; and a control unit configured to determine, based on the acquired use pattern, whether or not the control program regarding the on-vehicle control device is updatable.

(6) A method according to another aspect of the present disclosure is a method for controlling update of a control program of an on-vehicle control device configured to control a target device installed on a vehicle, and the method includes the steps of: acquiring a use pattern of a control function of the on-vehicle control device during traveling of the vehicle; and determining, based on the acquired use pattern, whether or not the control program is updatable.

(7) A computer program according to still another aspect of the present disclosure is a computer program for causing a computer to function as a control apparatus for controlling update of a control program of an on-vehicle control device configured to control a target device installed on a vehicle, and the computer program causes the computer to function as: an acquisition unit configured to acquire a use pattern of the control function of the on-vehicle control device during traveling of the vehicle; and a control unit configured to determine, based on the acquired use pattern, whether or not the control program is updatable.

### BRIEF DESCRIPTION OF DRAWINGS

FIG. 1 is a diagram showing an overall configuration of a program update system according to an embodiment.

FIG. 2 is a block diagram showing an internal configuration of a gateway.

FIG. 3 is a block diagram showing an internal configuration of an ECU.

FIG. 4 is a block diagram showing an internal configuration of a management server.

FIG. 5 is a sequence diagram showing an example of update of control programs for target ECUs.

FIG. 6 is a flowchart showing an example of a process of determining whether or not repro is executable.

FIG. 7 is a diagram for explaining an example of a process of generating use patterns.

### DESCRIPTION OF EMBODIMENTS

### Problems to be Solved by the Present Disclosure

In the vehicle control device of Patent Literature 1, a traveling route, which satisfies a condition (e.g., vehicle traveling condition, road condition, or surrounding environmental condition) on which the control function of an ECU to be updated is not operated, is set, and program update is executed while the vehicle is traveling on this traveling route.

Since the program update is executed while the vehicle is traveling, a traveling route that is not expected by the user of the vehicle may be set, which may annoy the user.

The present disclosure has been made in view of the above problems, and one object of the present disclosure is to provide a control apparatus and the like which are capable of appropriately determining whether or not a control program is updatable while a vehicle is traveling, even without setting a traveling route on which a vehicle control device will not execute a control function.

### Effect of the Disclosure

According to this disclosure, whether or not a control program is updatable during traveling of a vehicle can be appropriately determined, even without setting a traveling route on which a vehicle control device will not execute a control function.

### DESCRIPTION OF EMBODIMENTS

Hereinafter, outlines of embodiments of the present disclosure will be listed and described.

(1) A control apparatus according to one embodiment is an apparatus for controlling update of a control program of an on-vehicle control device configured to control a target device installed on a vehicle, and the apparatus includes: an acquisition unit configured to acquire a use pattern of the control function of the on-vehicle control device during traveling of the vehicle; and a control unit configured to determine, based on the acquired use pattern, whether or not the control program regarding the on-vehicle control device is updatable.

According to the control apparatus of the present embodiment, the acquisition unit acquires the use pattern of the control function of the on-vehicle control device during traveling of the vehicle, and the control unit determines, based on the acquired use pattern, whether or not the control program regarding the on-vehicle control device is updatable. Therefore, whether or not the control program is updatable during traveling of the vehicle can be appropriately determined, even without setting a traveling route on which the on-vehicle control device does not execute the control function.

(2) In the control apparatus of the present embodiment, the control unit determines, based on the acquired use pattern, the level of use possibility of the control function of the on-vehicle control device during traveling of the vehicle, and determines, based on the result of the determination, whether or not the control program is updatable.

(3) More specifically, when the use possibility is not higher than a predetermined threshold, the control unit determines that the control program is updatable.

Therefore, it is possible to avoid a situation that, when a user uses a certain control function, the user is recommended to update the control program of the on-vehicle control device corresponding to the control function, which makes the user feel inconvenient.

(4) In the control apparatus of the present embodiment, the use pattern preferably includes a use pattern that is set for identification information of each of users who can drive the vehicle.

In this case, the control unit can determine whether or not the control program of the on-vehicle control device is updatable, based on the use pattern for each user. Therefore, the update process by the on-vehicle control device can be allowed at appropriate timings that do not make the user feel inconvenient.

(5) In the control apparatus of the present embodiment, the user identification information preferably includes identification information in a case where the vehicle is an automated driving vehicle.

Thus, also for a vehicle that is automatically traveling, whether or not a control program of an on-vehicle control device thereof is updatable can be determined based on a use pattern.

(6) The control apparatus of the present embodiment preferably includes a generation unit configured to generate the use pattern, based on accumulated operation states of the control function.

When the use pattern is generated based on the accumulated operation states of the control function, accuracy of the use pattern can be improved. Therefore, whether or not the control program is updatable during traveling of the vehicle can be appropriately determined.

(7) A control method of the present embodiment relates to a control method executed by the control apparatus according to any one of the above (1) to (6).

Therefore, the control method of the present embodiment provides the same operation and effect as those of the control apparatus according to any one of the above (1) to (6).

(8) A computer program of the present embodiment is a computer program for causing a computer to function as a control apparatus described in any one of the above (1) to (6).

Therefore, the computer program of the present embodiment provides the same operation and effect as those of the control apparatus according to any one of the above (1) to (6).

### DETAILED DESCRIPTION OF EMBODIMENT

Hereinafter, preferred embodiments of the present disclosure will be described with reference to the drawings. At least some parts of the embodiments described below may be combined together as desired.

### [Overall Configuration of System]

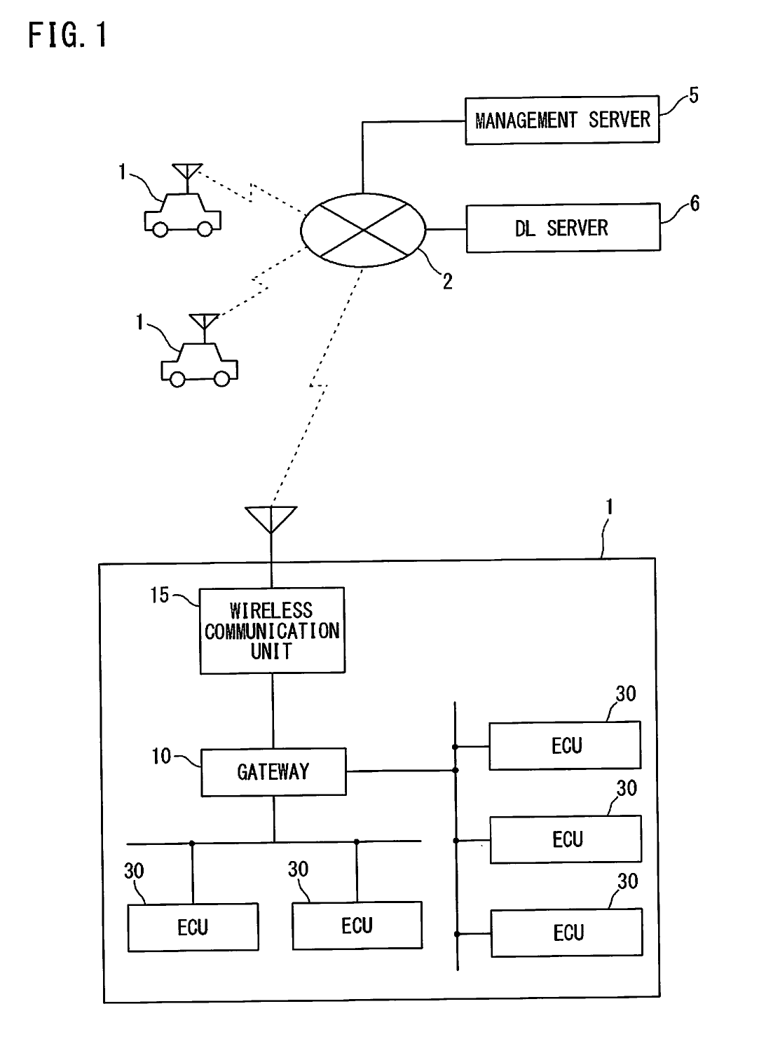

FIG. 1 is a diagram showing an overall configuration of a program update system according to an embodiment.

As shown in FIG. 1, the program update system of this embodiment includes vehicles 1, a management server 5, and a DL (download) server 6 which are able to communicate with each other via a wide-area communication network 2.

The management server 5 and the DL server 6 are operated by, for example, the automobile manufacturer of the vehicles 1, and are able to communicate with large numbers of vehicles 1 owned by users registered as members in advance.

Each vehicle 1 is equipped with a gateway 10, a wireless communication unit 15, a plurality of ECUs 30, and various on-vehicle devices (not shown) controlled by the respective ECUs 30.

A plurality of communication groups, each being formed by a plurality of ECUs 30 bus-connected to a common in-vehicle communication line, are present in the vehicle 1, and the gateway 10 relays communication between the communication groups. Therefore, a plurality of in-vehicle communication lines are connected to the gateway 10.

The wireless communication unit 15 is communicably connected to the wide-area communication network 2 such as a mobile phone network, and is connected to the gateway 10 via an in-vehicle communication line. The gateway 10 transmits, to the ECUs 30, information received by the wireless communication unit 15 from external devices, such as the management server 5 and the DL server 6, through the wide-area communication network 2.

The gateway 10 transmits information obtained from the ECUs 30 to the wireless communication unit 15, and the wireless communication unit 15 transmits the information to the external devices such as the management server 5.

As for the wireless communication unit 15 installed in the vehicle 1, a device possessed by the user, such as a mobile phone, a smart phone, a tablet-type terminal, or a notebook PC (Personal Computer) is conceivable.

FIG. 1 shows an exemplary case where the gateway 10 communicates with the external devices via the wireless communication unit 15. However, if the gateway 10 has a wireless communication function, the gateway 10 itself may wirelessly communicate with the external devices such as the management server 5.

In the program update system shown in FIG. 1, the management server 5 and the DL server 6 are configured as separate servers. However, these serves 5 and 6 may be configured as a single server unit.

### [Internal Configuration of Gateway]

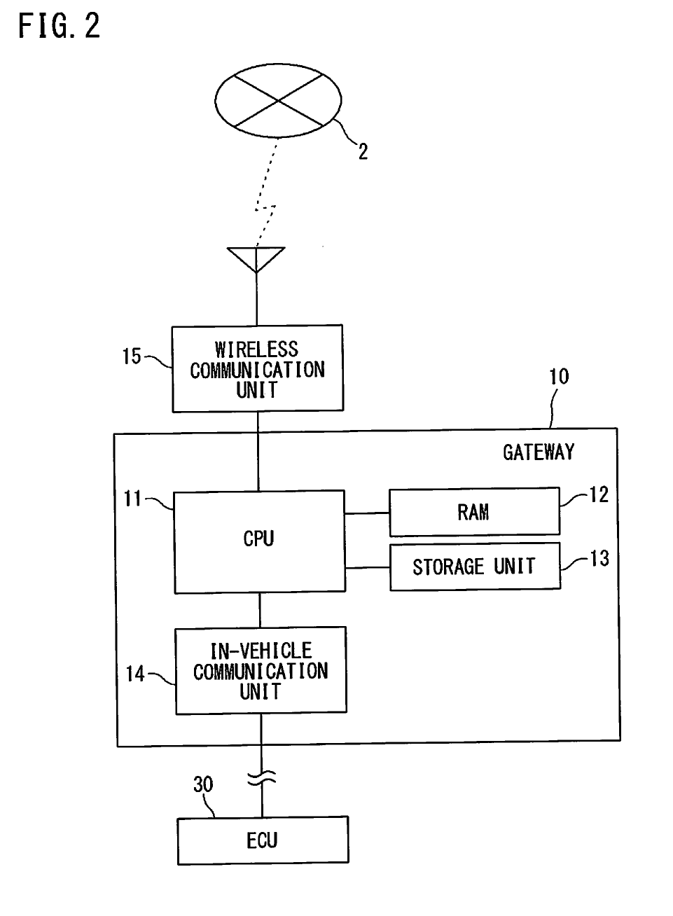

FIG. 2 is a block diagram showing the internal configuration of the gateway 10.

As shown in FIG. 2, the gateway 10 includes a CPU (Central Processing Unit) 11, an RAM (Random Access Memory) 12, a storage unit 13, an in-vehicle communication unit 14, and the like. Although the gateway 10 is connected to the wireless communication unit 15 via the in-vehicle communication line, the gateway 10 and the wireless communication unit 15 may be configured as a single unit.

The CPU 11 causes the gateway 10 to function as a relay device for relaying various kinds of information, by reading out one or a plurality of programs stored in the storage unit 13 to the RAM 12 and executing the read programs.

The CPU 11 can execute a plurality of programs in parallel by switching between the plurality of programs in a time sharing manner, for example.

The CPU 11 includes one or a plurality of large-scale integrated circuits (LSIs). In the CPU 11 including a plurality of LSIs, the plurality of LSIs implement the function of the CPU 11 in cooperation with each other.

The RAM 12 consists of a memory element such as an SRAM (Static RAM) or a DRAM (Dynamic RAM), and temporarily stores therein programs to be executed by the CPU 11, data required in executing the programs, and the like.

A computer program to be executed by the CPU 11 can be transferred in a state of being recorded in a well-known recording medium such as a CD-ROM or a DVD-ROM, or may be transferred by data transmission (downloading) from a computer device such as a server computer.

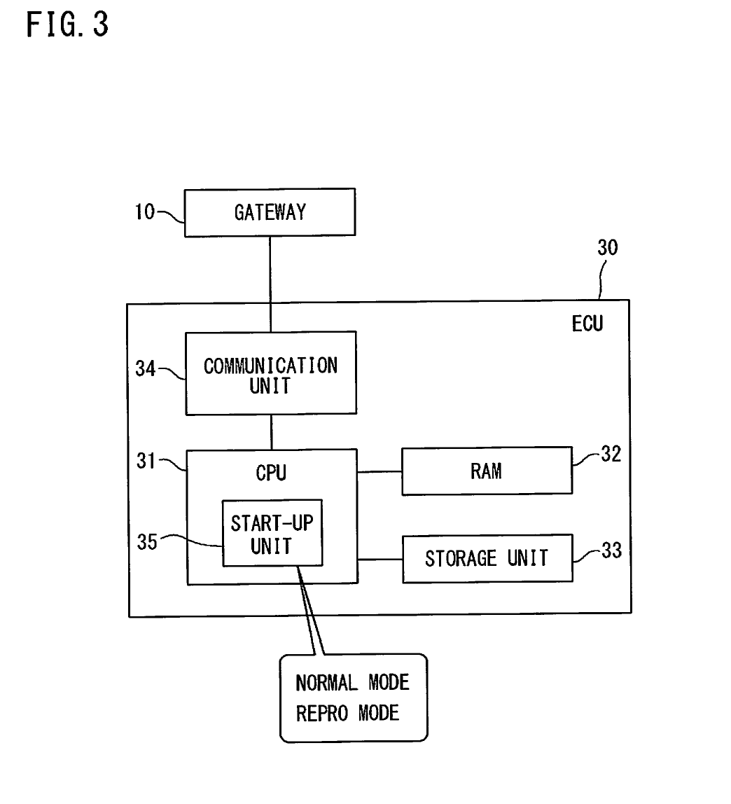

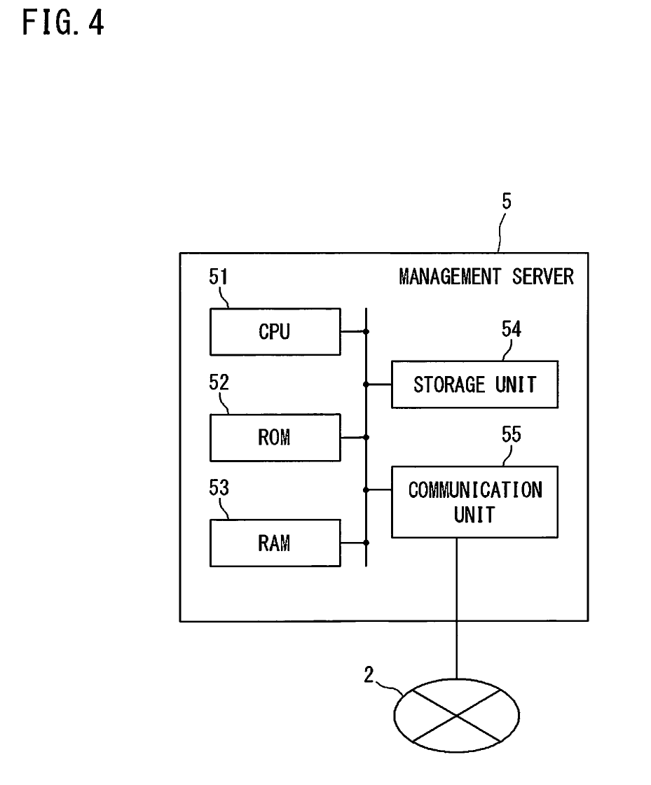

In this regard, the same applies to a computer program to be executed by a CPU 31 of the ECU 30 (refer to FIG. 3) described later, and a computer program to be executed by a CPU 51 of the management server 5 (refer to FIG. 4) described later.

The storage unit 13 consists of, for example, a nonvolatile memory element such as a flash memory or an EEPROM (Electrically Erasable Programmable Read Only Memory).

The storage unit 13 has a storage area in which programs to be executed by the CPU 11, data required in executing the programs, and the like are stored. The storage unit 13 further stores therein update programs of the respective ECUs 30, which are received from the DL server 6.

The plurality of ECUs 30 are connected to the in-vehicle communication unit 14 via the in-vehicle communication lines arranged in the vehicle 1. The in-vehicle communication unit 14 communicates with the ECUs 30 in accordance with a standard such as CAN (Controller Area Network), CANFD (CAN with Flexible Data Rate), LIN (Local Interconnect Network), Ethernet (registered trademark), or MOST (Media Oriented Systems Transport: MOST is a registered trademark), for example.

The in-vehicle communication unit 14 transmits information provided from the CPU 11 to target ECUs 30, and provides information received from the ECUs 30 to the CPU 11. The in-vehicle communication unit 14 may communicate with the ECUs 30 in accordance with other communication standards that are used for an on-vehicle network, apart from the above communication standards.

The wireless communication unit 15 consists of a wireless communication apparatus including an antenna and a communication circuit that executes transmission/reception of radio signals through the antenna. The wireless communication unit 15 is able to communicate with the external devices when connected to the wide-area communication network 2 such as a mobile phone network.

The wireless communication unit 15 transmits information provided from the CPU 11 to the external devices such as the management server 5 via the wide-area communication network 2 formed by a base station (not shown), and provides information received from the external devices to the CPU 11.

Instead of the wireless communication unit 15 shown in FIG. 2, a wired communication unit that serves as a relay device inside the vehicle 1 may be adopted. The wired communication unit has a connector to which a communication cable conforming to a standard such as USB (Universal Serial Bus) or RS232C is connected, and performs wired communication with another communication device connected thereto via the communication cable.

If the other communication device and the external device such as the management server 5 can wirelessly communicate with each other via the wide-area communication network 2, the external device and the gateway 10 are able to communicate with each other through a communication path consisting of the external device, the other communication device, the wired communication unit, and the gateway 10, in this order.

### [Internal Configuration of ECU]

FIG. 3 is a block diagram showing the internal configuration of an ECU 30.

As shown in FIG. 3, the ECU 30 includes a CPU 31, an RAM 32, a storage unit 33, a communication unit 34, and the like. The ECU 30 is an on-vehicle control device that individually controls a target device installed in the vehicle 1. Examples of the types of the ECU 30 include: traveling-related ECUs concerning, for example, an engine, a brake, a steering function, etc.; body-related ECUs concerning headlights, door locks, etc.; and automatic-traveling-related ECUs concerning lane keeping assistance, etc.

The CPU 31 controls the operation of a target device that the CPU 31 is in charge of, by reading out one or a plurality of programs previously stored in the storage unit 33 to the RAM 32 and executing the read programs. The CPU 31 includes one or a plurality of large-scale integrated circuits (LSIs). In the CPU 31 including a plurality of LSIs, the plurality of LSIs implement the function of the CPU 31 in cooperation with each other.

The RAM 32 consists of a memory element such as an SRAM or a DRAM, and temporarily stores therein programs to be executed by the CPU 31, data required in executing the programs, and the like.

The storage unit 33 consists of, for example, a nonvolatile memory element such as a flash memory or an EEPROM, or a magnetic storage device such as a hard disk.

Information stored in the storage unit 33 includes, for example, a computer program (hereinafter referred to as “control program”) that causes the CPU 31 to execute information processing for controlling a target device to be controlled, inside the vehicle.

The gateway 10 is connected to the communication unit 34 via the in-vehicle communication lines arranged in the vehicle 1. The communication unit 34 communicates with the gateway 10 in accordance with a standard such as CAN, Ethernet, or MOST, for example.

The communication unit 34 transmits information provided from the CPU 31 to the gateway 10, and provides information received from the gateway 10 to the CPU 31. The communication unit 34 may communicate with the gateway 10 in accordance with other communication standards that are used for the on-vehicle network, apart from the above communication standards.

The CPU 31 of the ECU 30 includes a start-up unit 35 that switches the mode of control performed by the CPU 31, between a “normal mode” and a “reprogramming mode” (hereinafter also referred to as “repro mode”).

The normal mode is a control mode in which the CPU 31 of the ECU 30 executes original control for the target device (e.g., engine control for a fuel engine, or door lock control for a door lock motor).

The reprogramming mode is a control mode in which the CPU 31 updates the control program used for controlling the target device.

That is, the reprogramming mode is a control mode in which the CPU 31 performs erasing/overwriting of the control program from/on an ROM area in the storage unit 33. Only when the CPU 31 is in this control mode, the CPU 31 is allowed to update the control program stored in the ROM area in the storage unit 33 to a new version of the control program.

When the CPU 31, in the repro mode, writes the new version of the control program into the storage unit 33, the start-up unit 35 temporarily restarts (resets) the ECU 30, and executes a verifying process on the storage area where the new version of the control program has been written.

After completion of the verifying process, the start-up unit 35 operates the CPU 31 with the updated control program.

### [Internal Structure of Management Server]

FIG. 4 is a block diagram showing the internal structure of the management server 5.

As shown in FIG. 4, the management server 5 includes a CPU 51, an ROM 52, an RAM 53, a storage unit 54, a communication unit 55, and the like.

By reading out one or a plurality of programs previously stored in the ROM 52 to the RAM 53 and executing the read programs, the CPU 51 controls the operation of each hardware component, and causes the management server 5 to function as an external device that is able to communicate with the gateway 10. The CPU 51 includes one or a plurality of large-scale integrated circuits (LSIs). In the CPU 51 including a plurality of LSIs, the plurality of LSIs implement the function of the CPU 51 in cooperation with each other.

The RAM 53 consists of a memory element such as an SRAM or a DRAM, and temporarily stores therein programs to be executed by the CPU 51, data required in executing the programs, and the like.

The storage unit 54 consists of, for example, a nonvolatile memory element such as a flash memory or an EEPROM, or a magnetic storage device such as a hard disk.

The communication unit 55 consists of a communication device that executes a communication process in accordance with a predetermined communication standard. The communication unit 55 executes the communication process when connected to the wide-area communication network 2 such as a mobile phone network. The communication unit 55 transmits information provided from the CPU 51 to external devices via the wide-area communication network 2, and provides information received via the wide-area communication network 2 to the CPU 51.

Information stored in the storage unit 54 includes: personal information of users as registered members; a service management table (not shown) for managing, for example, version information of control programs to be executed by ECUs 30 installed in vehicles 1; and the like.

The service management table is, for example, a reference table that tabulates: vehicle identification numbers (VIN) of vehicles 1 owned by the registered members; the types of ECUs 30 corresponding to each vehicle identification number; and histories of version information of control programs to be executed by the respective ECUs 30.

The DL server 6 stores therein, for all types of ECUs 30, update programs for different versions of control programs to be executed by the ECUs 30.

Each update program stored in the DL server 6 may be a latest version of control program itself to be installed on the corresponding ECU 30, or may be a difference program between an old version of control program and a new version of control program (hereinafter, an update program composed of a difference program may be denoted by “A”).

The gateway 10 of the vehicle 1 transmits a communication packet including: version information of control programs being used by the ECUs 30 installed in the vehicle 1; and the vehicle identification number of the vehicle 1, to the management server 5 at predetermined time intervals.

Upon receiving the communication packet from the gateway 10, the CPU 51 of the management server 5 determines, with reference to the service management table, whether or not the version information of each control program included in the communication packet is the latest version.

When the result of the determination is that the version information of any of the control programs notified from the gateway 10 is not the latest one, the CPU 51 transmits, to the gateway 10, a communication packet including a URL in the DL server 6 where the corresponding update program is stored.

Upon receiving the communication packet, the gateway 10 transmits, to the DL server 6, a download request including: the URL notified from the management server 5; and the type of the ECU 30 for which reprogramming is to be executed.

Upon receiving the download request, the DL server 6 transmits, to the gateway 10 as a download request transmission source, an update program corresponding to the type of the ECU 30 notified from the gateway 10.

Upon receiving the update program, the CPU 31 of the gateway 10 transfers the received update program to the ECU 30 to cause the ECU 30 to execute a process of updating the control program to the latest version.

### [Control Program Update Sequence]

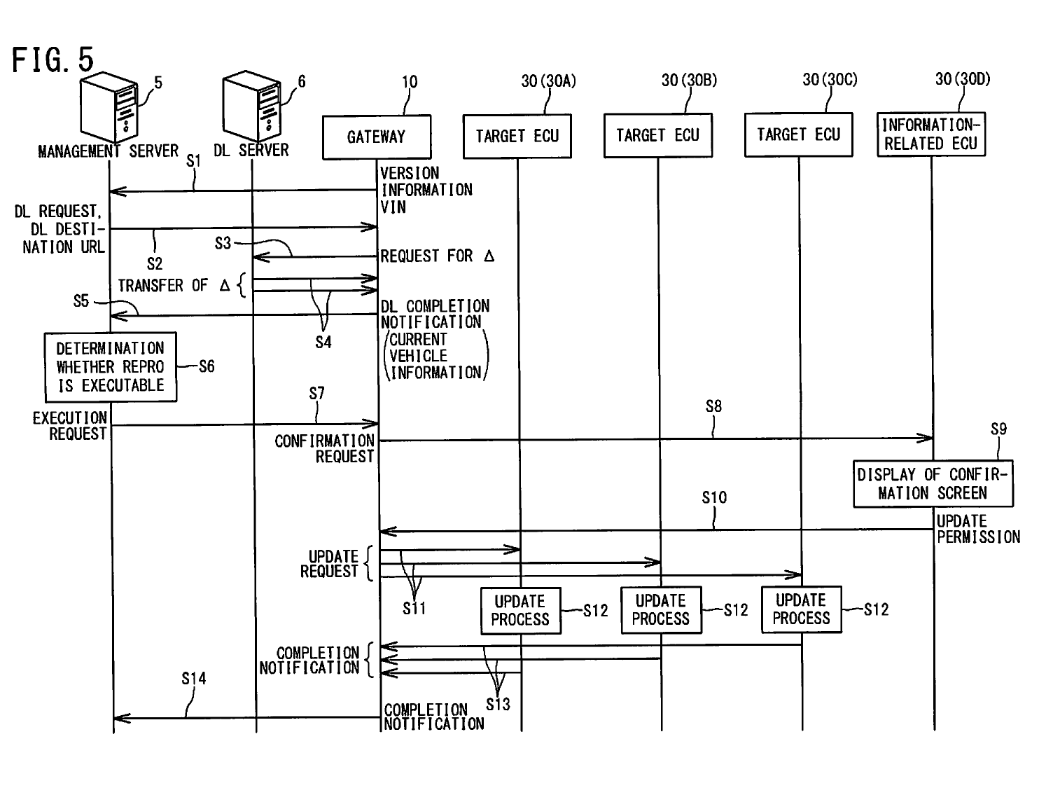

FIG. 5 is a sequence diagram showing an example of control program update for target ECUs 30A to 30C, which is executed in the program update system of the present embodiment.

In FIG. 5, a “target ECU” is an ECU 30 whose control program is to be updated, and an “information-related ECU” is an ECU 30 that controls information-related target devices such as a car navigation device, and a liquid crystal display (display unit) and an input unit of the car navigation device.

As shown in FIG. 5, the gateway 10 transmits, to the management server 5, a communication packet including: version information of control programs of target ECUs 30A to 30C of the vehicle 1; the vehicle identification number (VIN) of the vehicle 1; and the like (step S1).

Upon receiving the communication packet, the management server 5 searches the aforementioned service management table, based on the version information and the vehicle identification number included in the communication packet, thereby determining whether or not the control programs regarding the target ECUs 30A to 30C need to be updated.

Here, it is assumed that the management server 5 has determined that the target ECUs 30A to 30C of the vehicle 1 need to be updated.

In this case, the management server 5 transmits, to the gateway 10 which is a packet transmission source, a download request including a destination URL where update programs for the target ECUs 30A to 30C are stored (i.e., URL of an update program storage folder in the DL server 6) (step S2).

Next, the gateway 10 accesses the destination URL, and transmits, to the DL server 6, a communication packet that requests update programs Δ for the target ECUs 30A to 30C (step S3). Then, the DL server 6 transfers the update programs Δ to the gateway 10 (step S4).

Upon completing download of the update programs, the gateway 10 temporarily stores and preserves the update programs in the storage unit 13 thereof, and transmits a download completion notification to the management server 5 (step S5).

In the present embodiment, the gateway 10 includes, in the download completion notification, current vehicle information of the vehicle 1, which is used by the management server 5 for “repro execution determination process” described later (step S6).

The current vehicle information includes, for example, a user ID, driving state (any of parking/stopping/traveling), present position, present time, OD (Origin-Destination) information (including traveling route), remaining battery level, etc.

The user ID is identification information defined independent of the vehicle identification information so as to identify the driver of the vehicle 1. User IDs of a plurality of users who drive the same vehicle 1 can be defined by using smart key information or the like.

For example, when one vehicle 1 is shared by three users (e.g., the owner of the vehicle 1, his/her spouse, and their eldest son), values of three pieces of smart key information corresponding to one vehicle identification information (VIN) may be used as user IDs of the respective users.

Upon receiving the download completion notification, the management server 5 executes the “repro execution determination process” (step S6).

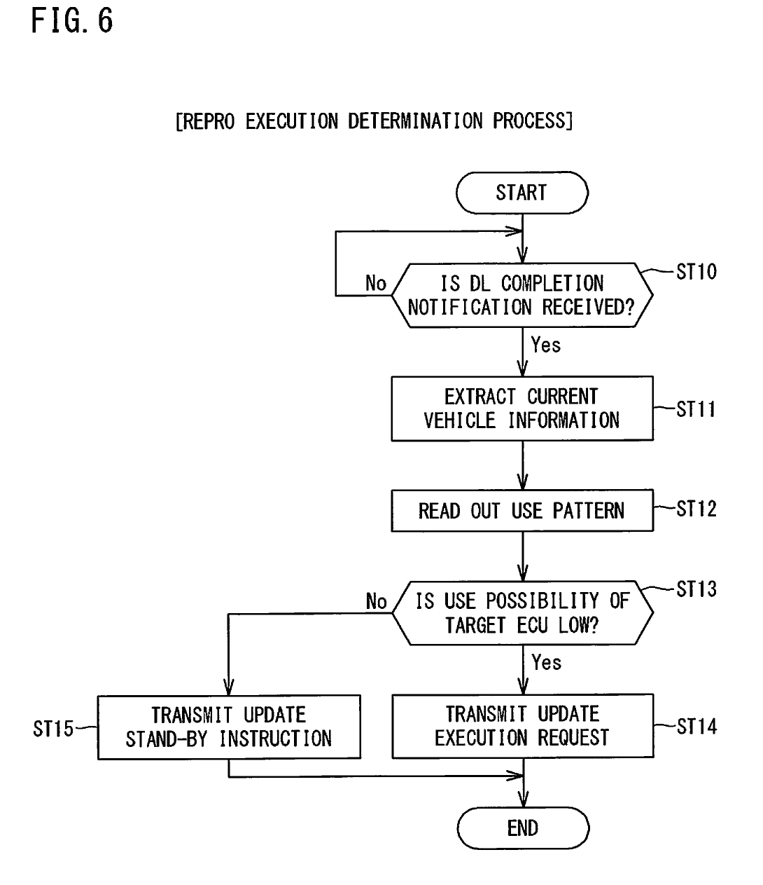

This determination process is a process of determining whether or not update of the control programs of the target ECUs 30A to 30C is executable, according to use possibilities of control functions to be executed by the target ECUs 30A to 30C. The use possibilities of the control functions of the target ECUs 30A to 30C are determined based on use patterns that are stored in the management server 5 in advance. The details of the repro execution determination process (FIG. 6) based on the use patterns will be described later.

Here, it is assumed that the result of the repro execution determination by the management server 5 is positive (repro is executable). In this case, the management server 5 transmits a control program update execution request to the gateway 10 (step S7).

Upon receiving the execution request, the gateway 10 transmits a confirmation request to an information-related ECU 30D to cause the user to confirm whether or not update of the control programs using the update programs Δ is necessary (step S8).

Upon receiving the confirmation request, the information-related ECU 30D causes the display device such as the liquid crystal display of the car navigation device to display an execution necessity confirmation screen (step S9).

This confirmation screen includes a display that allows the user to select whether or not update of the control programs is executed. For example, the confirmation screen displays a message such as “Will you update control programs of target ECUs 30A to 30C?” or “Control programs of target ECUs 30A to 30C are updatable. Update now? Later?”.

Here, it is assumed that a user selects execution of update of the control programs regarding the target ECUs 30A to 30C, through an operation input to the input device of the vehicle 1.

In this case, an input signal of update execution is transmitted to the information-related ECU 30D, and the information-related ECU 30D transmits an update permission to the gateway 10 (step S10). Upon receiving the update permission, the gateway 10 transmits a control program update request to each of the target ECUs 30A to 30C (step S11), and transfers the update programs Δ to the target ECUs 30A to 30C.

Upon receiving the update request, each of the target ECUs 30A to 30C executes a control program update process (step S12).

Specifically, the start-up unit 35 of the CPU 31 of each of the target ECUs 30A to 30C switches the control mode of the ECU from the normal mode to the repro mode (refer to FIG. 3), develops the received update program A to be applied to the old version of control program, whereby the control program is rewritten from the old version to the new version.

Upon completion of the control program update process, each of the target ECUs 30A to 30C transmits an update process completion notification thereof to the gateway 10 (step S13).

Upon receiving the completion notification, the gateway 10 transmits, to the management server 5, the vehicle identification number of the vehicle 1, and a completion notification indicating that the update processes for the target ECUs 30A and 30B are completed (step S14).

Upon receiving the completion notification, the management server 5 updates the content of the service management table managed thereby.

Specifically, the management server 5 searches for the vehicle identification number included in the completion notification received from the gateway 10, and updates the version information of the control programs of the target ECUs 30A to 30C associated with the identification number, to the new version.

### [Repro Execution Determination Process]

FIG. 6 is a flowchart showing an example of the repro execution determination process to be executed by the CPU 51 of the management server 5.

As shown in FIG. 6, the CPU 51 of the management server 5 continuously determines whether or not a downlink completion notification is received from the gateway 10 (step ST10).

Upon receiving a download completion notification, the CPU 51 extracts current vehicle information of the corresponding vehicle 1 from the completion notification (step ST11), and reads out, from the storage unit 54 of the management server 5, “use patterns” of the control functions of the target ECUs 30A to 30C during traveling of the vehicle 1 (step ST12).

A use pattern means a use tendency of a control target of an ECU 30 by the user of the vehicle 1, for example, what kind of situation under which a specific user or general users use or do not use the control target of the ECU 30.

Next, the CPU 51 of the management server 5 determines whether or not use possibilities of the target ECUs 30A to 30C during traveling of the vehicle 1 are low, based on the current vehicle information of the vehicle 1, and on the use patterns, during traveling of the vehicle 1, which are stored in the management server 5 (step ST13).

Specifically, for example, the CPU 51 determines that the use possibilities of the target ECUs 30A to 30C are low when the use possibilities based on the use patterns are not higher than a predetermined threshold (e.g., 5%), whereas the CPU 51 determines that the use possibilities are high when the use possibilities exceed the predetermined threshold.

When the determination result in step ST13 is positive, the CPU 51 transmits an update execution request to the gateway 10 (step ST14).

Upon receiving the execution request, the gateway 10 transmits a confirmation request to the information-related ECU 30D of the vehicle 1 as described above (step S8 in FIG. 5). Thus, the user of the vehicle 1 is inquired as to whether execution of update for the target ECUs 30A to 30C is necessary (step S9 in FIG. 5).

When the determination result in step ST13 is negative, the CPU 51 transmits an update stand-by instruction to the gateway 10 (step ST15).

This stand-by instruction consists of a communication packet that instructs retransmission of a download completion notification to be performed after a predetermined time period (e.g., about one hour to one day) has passed. Therefore, the CPU 51 of the management server 5 executes the repro execution determination process (FIG. 6) again, upon receiving a download completion notification from the gateway 10 after the predetermined time period has passed.

Next, specific examples 1 to 3 of the determination method in step ST13 will be described.

### Specific Example 1 of Determination Method

In the specific example 1 of the determination method, it is assumed that the control function of the target ECU 30A to be updated is “automatic lighting” (function of turning on/off headlights or the like in accordance with external illumination).

It is assumed that the use pattern stored in the management server 5 in this case is “the possibility that a user 1 uses automatic lighting is 1%”.

In this case, when the user ID included in the download completion notification from the gateway 10 is “user 1”, the CPU 51 of the management server 5 determines that the use possibility of the target ECU 30A is low (Yes in step ST13), and transmits an update execution request regarding the target ECU 30A (step ST14).

Alternatively, it is assumed that the use pattern stored in the management server 5 is “the possibility that the user 1 uses automatic lighting during daytime hours (12:00 to 15:00) is 1%, and the possibility that the user 1 uses automatic lighting in other time periods is 10%”.

In this case, when the user ID notified from the gateway 10 is “user 1” and the present time is in the time period other than the above daytime hours, the CPU 51 of the management server 5 determines that the use possibility of the target ECU 30A is high (No in step ST13), and transmits an update stand-by request regarding the target ECU 30A (step ST15).

Alternatively, it is assumed that the use pattern stored in the management server 5 is “the possibility that the user 1 uses automatic lighting when passing through a tunnel is 20%, and the possibility that the user 1 uses automatic lighting in other areas is 1%”.

In this case, when the user ID notified from the gateway 10 is “user 1” and it is expected that the vehicle 1 is traveling in a tunnel area, based on the present time and the OD information, the CPU 51 of the management server 5 determines that the use possibility of the target ECU 30A is high (No in step ST13), and transmits an update stand-by request regarding the target ECU 30A (step ST15).

### Specific Example 2 of Determination Method

In the specific example 2 of the determination method, it is assumed that the control function of the target ECU 30B to be updated is “lane keeping assist” (function of performing automatic steering to keep a lane: hereinafter also referred to as “LKA”).

Here, it is assumed that the use pattern stored in the management server 5 is “the possibility that a user 2 uses LKA on a predetermined road section of a freeway is 1%”.

In this case, when the user ID included in the download completion notification from the gateway 10 is “user 2” and it is expected that the vehicle 1 is traveling on the predetermined road section, based on the present time, the present position, the OD information, etc., the CPU 51 of the management server 5 determines that the use possibility of the target ECU 30B is low (Yes in step ST13), and transmits an update execution request regarding the target ECU 30B (step ST14).

### Specific Example 3 of Determination Method

In the specific example 3 of the determination method, it is assumed that the control function of the target ECU 30C to be updated is “wiper control”.

Here, it is assumed that the use pattern stored in the management server 5 is “the possibility that a user 3 uses wipers while driving in a clear day is 30%”.

In this case, when the user ID included in the download completion notification from the gateway 10 is “user 3” and the present weather is clear, the CPU 51 of the management server 5 determines that the use possibility of the target ECU 30C is high (No in step ST13), and transmits an update stand-by request regarding the target ECU 30C (step ST15).

### [Use Pattern Generation Process]

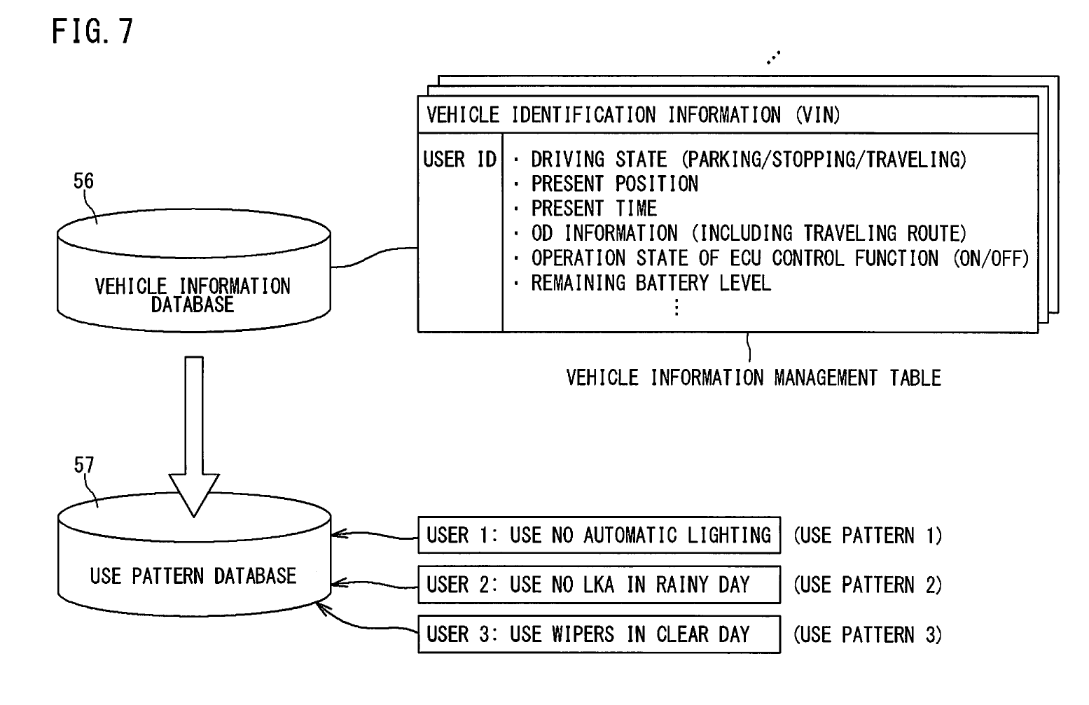

FIG. 7 is a diagram showing an example of a use pattern generation process to be executed by the CPU 51 of the management server 5. The “use pattern generation process” is a process of generating a use pattern (use tendency) of a predetermined ECU control function, based on vehicle information acquired from a vehicle 1, and on information (weather, road type, etc.) that can be acquired by the management server 5 from apparatuses other than the vehicle 1.

As shown in FIG. 7, in the storage unit 54 of the management server 5, a vehicle information database 56 and a use pattern database 57 are stored.

The vehicle information database 56 contains a plurality of “vehicle information management tables”. Vehicle information contained in each management table is extracted from a communication packet that is received from the gateway 10 of the vehicle 1 by the management server 5 at predetermined time intervals (e.g., 1 to 5 seconds).

The vehicle information includes information about each vehicle 1, such as vehicle identification information (VIN), user ID, driving state (any of parking/stopping/traveling), present position, present time, OD (Origin-Destination) information (including a traveling route), and operation state (either ON or OFF) of each ECU control function.

One vehicle information management table includes the driving state, the present position, and the like for each user ID regarding one vehicle identification number.

Upon receiving a communication packet including a predetermined vehicle identification number from the gateway 10, the CPU 51 of the management server 5 stores the information contained in the received communication packet, such as the user ID, driving state, present position, present time, etc., on the vehicle information management table corresponding to the vehicle identification number. The storage period is several months to one year, for example.

The CPU 51 of the management server 5 executes predetermined statistical processing on the vehicle information stored in the database 56, thereby generating the database 57 of the use patterns of the respective users.

For example, the CPU 51 extracts, from the vehicle information management table for the user 1 included in the vehicle information database 56, an explanatory variable that influences the operation state of a predetermined control function (e.g., automatic lighting), thereby generating a use pattern 1 for the user 1 regarding automatic lighting.

Further, the CPU 51 extracts, from the vehicle information management table for the user 2 included in the vehicle information database 56, an explanatory variable that influences the operation state of a predetermined control function (e.g., LKA), thereby generating a use pattern 2 for the user 2 regarding LKA.

Further, the CPU 51 extracts, from the vehicle information management table for the user 3 included in the vehicle information database 56, an explanatory variable that influences the operation state of a predetermined control function (e.g., wiper control), thereby generating a use pattern 3 for the user 3 regarding wiper control.

### Effects of Present Embodiment

As described above, according to the management server 5 of the present embodiment, the storage unit 54 acquires the use patterns of the control functions of the target ECUs 30A to 30C during traveling of the vehicle, and the CPU 51 determines, based on the acquired use patterns, whether or not the control programs of the target ECUs 30A to 30C are updatable. Therefore, whether or not the control programs are updatable during traveling of the vehicle can be appropriately determined, even without setting traveling routes on which the target ECUs 30A to 30C do not execute the control functions.

Specifically, the CPU 51 determines the levels of the use possibilities of the target ECUs 30A to 30C during traveling of the vehicle, based on the acquired use patterns (steps ST12 and ST13 in FIG. 6), and determines whether or not the control programs are updatable, based on the determination result (steps ST14 and ST15 in FIG. 6).

That is, when the use possibilities of the target ECUs 30A to 30C during traveling of the vehicle are not higher than a predetermined threshold, the CPU 51 determines that the control programs are updatable.

Therefore, it is possible to avoid a situation that, when the user uses a certain control function (e.g., the aforementioned “automatic lighting”, “LKA”, “wiper control”, or the like), the user is recommended to update the control program of any of the target ECUs 30A to 30C corresponding to this control function, which makes the user feel inconvenient.

According to the management server 5 of the present embodiment, the use patterns stored in the storage unit 54 include the use patterns 1 to 3 set for the respective pieces of identification information of the users (users 1 to 3) who can drive the vehicle 1 (refer to FIG. 7).

Therefore, the CPU 51 can execute determination as to whether the control programs of the target ECUs 30A to 30C are updatable, based on the use patterns 1 to 3 of the respective users 1 to 3. Accordingly, an update process execution request (step S7 in FIG. 5) can be transmitted at appropriate timing that does not make each of the users 1 to 3 feel inconvenient.

### First Modification

In the above-described embodiment, since user IDs of a plurality of drivers who drive the same vehicle 1 are defined by using smart key information or the like, the users who are identifiable by the user IDs are limited to persons who actually drive the vehicle 1.

However, assuming that almost completely automated driving will be put to practical use in future, it is desirable that user IDs include identification information in the case where the vehicle 1 is an automated driving vehicle.

For example, in the case of completely automated driving in level 4 (automated driving in which an occupant just needs to set a destination, and need not perform any driving operation) defined by National Highway Traffic Safety Administration (NHTSA) in the USA, it is desirable that a user ID is assigned to such an automated driving mode.

Thus, also for a vehicle 1 that is automatically driven, whether or not the control programs of the ECUs 30A to 30C are updatable can be determined based on use patterns.

### Second Modification

In the above-described embodiment, the management server 5 transmits an execution request to the gateway 10 of the vehicle 1 in order to inquire the user of the vehicle 1 as to whether update of the control programs is necessary (step S7 in FIG. 5). However, in the case where a business entity having a plurality of business-use vehicles, such as a taxi company or a bus company, owns a business server, and this business server collectively manages control programs of the business-use vehicles, the management server 5 may transmit an execution request to the business server.

### Third Modification

In the above-described embodiment, the CPU 51 of the management server 5 executes the process of determining, based on the use patterns, whether or not the control programs of the target ECUs 30A to 30C are updatable. However, the CPU 11 of the gateway 10 may execute this process. That is, the entity that executes determination as to whether or not update is possible may be the gateway 10.

In this case, the gateway 10 may create use patterns, of control functions of ECUs 30, regarding users of the vehicle 1, or may receive use patterns from the management server 5.

It is noted that the embodiments disclosed herein are merely illustrative in all aspects and should not be recognized as being restrictive. The scope of the present invention is defined not by the above description but by the scope of the claims, and is intended to include meaning equivalent to the scope of the claims and all modifications within the scope.

### REFERENCE SIGNS LIST

1 vehicle
2 wide-area communication network
5 management server (control apparatus)
6 DL server
10 gateway (control apparatus)
11 CPU (control unit)
12 RAM
13 storage unit (acquisition unit)
14 in-vehicle communication unit
15 wireless communication unit
30 ECU (on-vehicle control device)
30A target ECU (on-vehicle control device)
30B target ECU (on-vehicle control device)
30C target ECU (on-vehicle control device)
30D information-related ECU
31 CPU
32 RAM
33 storage unit
34 communication unit
35 start-up unit
51 CPU (control unit)
52 ROM
53 RAM
54 storage unit (acquisition unit)
55 communication unit
56 vehicle information database
57 use pattern database

1. A control apparatus configured to determine whether or not a control program is updatable, the control program being a control program of plural types of on-vehicle control devices configured to control a target device installed on a vehicle, the control apparatus comprising:
an acquisition unit configured to acquire a use possibility of a control function of the on-vehicle control device during traveling of the vehicle for each corresponding the on-vehicle control device; and
a control unit configured to determine, based on a level of the acquired use possibility, whether or not the control program regarding the on-vehicle control device is updatable.

2. (canceled)

3. The control apparatus according to claim 1, wherein
the control unit determines that the control program is updatable when the use possibility is not higher than a predetermined threshold.

4. The control apparatus according to claim 1, wherein
the use possibility includes a use possibility that is set for identification information of each of users who can drive the vehicle.

5. The control apparatus according to claim 4, wherein
the pieces of identification information of the users include identification information in a case where the vehicle is an automated driving vehicle.

6. The control apparatus according to claim 1, further comprising a generation unit configured to generate the use possibility, based on accumulated operation states of the control function.

7. A method for determining whether or not a control program is updatable, the control program being a control program of plural types of on-vehicle control devices configured to control a target device installed on a vehicle, the method comprising the steps of:
acquiring a use possibility of a control function of the on-vehicle control device during traveling of the vehicle for each corresponding the on-vehicle control device; and
determining, based on a level of the acquired use possibility, whether or not the control program regarding the on-vehicle control device is updatable.

8. A non-transitory computer readable storage medium storing a computer program for causing a computer to function as a control apparatus configured to determine whether or not a control program is updatable, the control program being a control program of plural types of on-vehicle control devices configured to control a target device installed on a vehicle, the computer program causing the computer to function as:
an acquisition unit configured to acquire a use possibility of a control function of the on-vehicle control device during traveling of the vehicle for each corresponding the on-vehicle control device; and
a control unit configured to determine, based on a level of the acquired use possibility, whether or not the control program regarding the on-vehicle control device is updatable.
